(19) United States
(12) Patent Application Publication
(10) Pub. No.: US 2014/0302422 A1
(43) Pub. Date: Oct. 9, 2014

(54) Magnesium Energy Storage Device Having a Semi-Solid Positive Electrode

(71) Applicant: BATTELLE MEMORIAL INSTITUTE, Richland, WA (US)

(72) Inventors: Yuyan Shao, Richland, WA (US); Jun Liu, Richland, WA (US); Guosheng Li, Richland, WA (US); Tianbiao Liu, Richland, WA (US)

(21) Appl. No.: 13/937,515

(22) Filed: Jul. 9, 2013

Related U.S. Application Data
(63) Continuation-in-part of application No. 13/858,764, filed on Apr. 8, 2013.

(51) Int. Cl. H01M 8/02; H01M 8/18; H01M 8/20

(52) U.S. Cl. CPC H01M 8/02; H01M 8/20; H01M 8/188
USPC 429/498; 429/517

(57) ABSTRACT

Magnesium energy storage devices that take advantage of magnesium-based anodes while maintaining practical energy densities can be useful for large-scale energy storage as well as other applications. One such device can include a negative electrode having magnesium and a positive electrode material that can flow in a batch or continuous manner. The flowable positive electrode material can result in an increased practical energy density because the fresh active material can be flowed to the positive electrode, and as a result can be theoretically infinite in size. The positive electrode can include a cathode suspension contacting a positive current collector and having particulates of a cathode magnesium intercalation compound, a cathode magnesium conversion compound, a redox active species, or combinations thereof.

### CROSS-REFERENCE TO RELATED APPLICATIONS

This invention claims priority from, and is a continuation in part of, currently pending patent application Ser. No. 13/858,764, filed Apr. 8, 2013 (Attorney Docket No. 30259-E), and is incorporated herein by reference.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Magnesium-based energy storage devices are attractive because of benefits associated with the cost, safety, and high volumetric capacity of Mg. However, magnesium metal anodes and magnesium intercalation anodes have electrode potentials that are approximately one volt higher than those of lithium. When coupled with a cathode, compared to lithium, the working voltage of magnesium cells is lower. This can mean that the energy density of magnesium batteries is also decreased. Therefore, a need exists for magnesium energy storage devices that take advantage of magnesium-based anodes while maintaining high energy densities.

### SUMMARY

This document describes an energy storage device having a negative electrode comprising magnesium and a semi-solid positive electrode material that can flow in a batch or continuous manner. The semi-solid positive electrode material can result in an increased practical energy density because fresh active material can be flowed to the positive electrode, and as a result can be theoretically infinite in size.

In one embodiment, the energy storage device has a positive electrode, a negative electrode, and a separator separating the positive and negative electrodes. The negative electrode comprises magnesium and the positive electrode comprises a cathode suspension contacting a positive current collector. The cathode suspension comprises particulates of a cathode magnesium intercalation compound, a cathode magnesium conversion compound, or a redox active species. One example of a cathode magnesium intercalation compound can include, but is not limited to, Mo₆S₈. In some instances, the energy storage device can further comprise a reservoir having a quantity of the cathode suspension and being connected to the positive electrode. The energy storage device can further comprise an inlet and an outlet through which the cathode suspension flows to and from the positive electrode, respectively.

“Electrode” as used herein can comprise the active material, conductive material, and/or electrolyte involved with the electrochemical reactions of the energy storage device. It can encompass configurations that are static or flowing. For example, the electrode can comprise a static, monolithic, solid material. Alternatively, the electrode can comprise a material that can flow in a batch or continuous manner. As used herein, “semi-solid” refers to a material intermediate in properties, especially in rigidity, between solids and liquids. “Suspension” can refer to a heterogeneous mixture comprising solid particulates dispersed throughout a fluid. Examples of certain kinds of suspensions can include, but are not limited to slurries, pastes, and colloids.

In some embodiments, the negative electrode comprises magnesium metal. Alternatively, the negative electrode can comprise a magnesium intercalation compound and/or a magnesium conversion compound. Preferably the negative electrode comprises a static electrode, however embodiments in which the negative electrode can flow are encompassed herein. For instance, a flowable negative electrode can comprise an anode suspension contacting a negative electrode current collector.

Embodiments described herein can utilize any conventional electrolyte suitable for magnesium batteries. Examples of conventional electrolytes can include, but are not limited to, magnesium bis(tri-fluoromethane sulfonyl)-imide and magnesium perchlorate. For embodiments encompassing negative electrodes comprising magnesium metal, the energy storage device can further comprise an electrolyte solution that facilitates high device performance and reversible plating and stripping of magnesium at the negative electrode. In one instance, the negative electrode comprises magnesium metal and is preferably substantially monolithic. In another instance, the negative electrode comprising magnesium metal can be arranged as an anode suspension such that it can be flowed in a batch or continuous manner.

An example of a high performance electrolyte solution includes, but is not limited to, one that has an organic solvent selected from the group consisting of diglyme, triglyme, tetraglyme, and combinations thereof. The electrolyte solution further comprises a first salt substantially dissolved in the organic solvent and comprising a magnesium cation, and a second salt substantially dissolved in the organic solvent and comprising a magnesium cation or a lithium cation, wherein the first salt, the second salt, or both comprise a BH₄ anion.

In another example, the electrolyte solution can comprise a magnesium salt and a Lewis acid in an organic solvent. Examples of a magnesium salt include, but are not limited to MgCl₂ and phenyl magnesium chloride. Examples of Lewis acid s can include, but are not limited to, AlCl₃, AlCl₂Et, or both. According to one embodiment in which the electrolyte solution comprises MgCl₂ and a Lewis acid, the positive electrode can comprise a suspension having a redox active species comprising sulfur. For example, the redox active species can comprise sulfur and/or MgS.

In other embodiments, the negative electrode comprises an anode magnesium intercalation compound, an anode magnesium conversion material, or both. The negative electrode can be static or it can comprise an anode suspension, which is flowable and contacts a negative electrode current collector. In some instances, a reservoir can provide the anode suspension to the negative electrode. The energy storage systems can further comprise an electrolyte comprising magnesium cations. Examples can include, but are not limited to Mg(TFSI)₂, Mg(PF₆)₂, and Mg(SO₃CF₃)₂. Solvents can include, but are not limited to THF, glymes, organic carbonates, and ethers.

In yet another embodiment, the energy storage system comprises a stack having a plurality of cells, each cell having a positive electrode comprising a suspension having particulates of a cathode magnesium intercalation or conversion compound contacting a positive electrode current collector, a negative electrode comprising magnesium, a separator between the positive and negative electrodes, and at least one reservoir providing the suspension to the cells. In preferred embodiments, the negative electrode in each cell is a static electrode and comprises magnesium metal. The cathode magnesium intercalation compound can comprise Mo₆S₈.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 includes a schematic diagram depicting an energy storage device having a cathode suspension according embodiments described herein.

FIG. 2 includes a schematic diagram depicting an energy storage device having anode and cathode suspensions according to embodiments described herein.

FIG. 3 includes a graph of voltage as a function of capacity for a traditional magnesium coin cell compared to an energy storage device with a semi-solid cathode according to embodiments described herein

FIG. 4 includes a graph of capacity as a function of cycle number for an energy storage device having a semi-solid cathode according to embodiments described herein.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

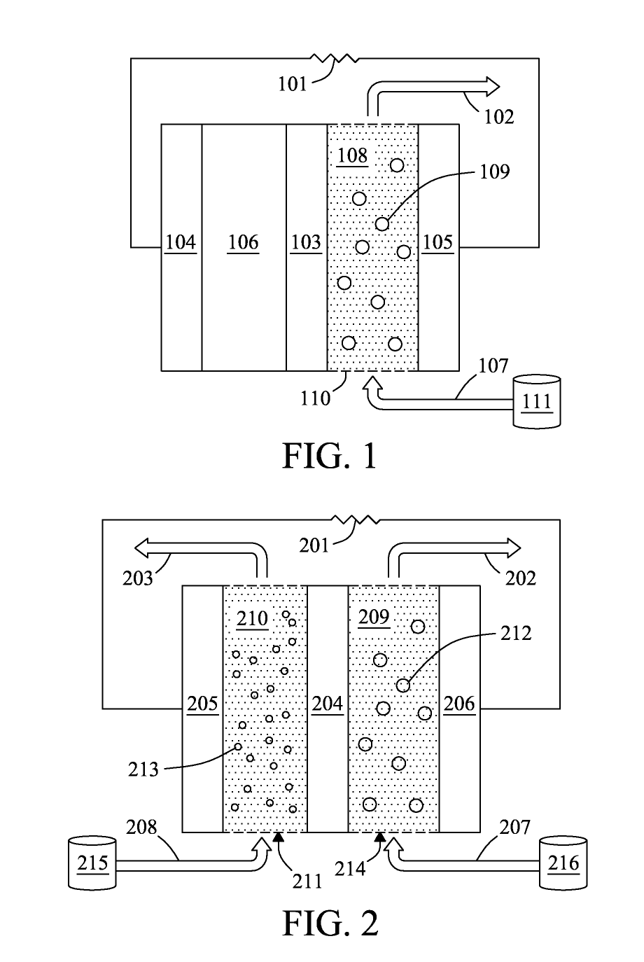

FIGS. 1-4 show a variety of aspects and embodiments of the present invention. Referring first to FIG. 1 a schematic diagram of one embodiment depicts an energy storage device having a static negative electrode material 106 and a positive electrode comprising a cathode suspension 108. The negative electrode material can comprise magnesium metal, an anode magnesium intercalation compound, and/or an anode magnesium conversion compound. The cathode suspension comprises particulates 109 of a cathode magnesium intercalation compound, a cathode magnesium conversion compound or both. An optional negative electrode current collector 104 is shown in addition to a positive electrode current collector 105. The positive and negative electrodes are separated by a separator 103. Furthermore, the cathode suspension can optionally flow into the positive electrode along pathway 107 and out the positive electrode along pathway 102. Pathways 107 and 102 can be embodied by inlets and outlets to the positive electrode volume 110. Alternatively, a single port can be used to remove and fill the positive electrode volume with the cathode suspension. Flow of the cathode suspension can be provided by a pump, a piston, or any other means of moving a suspension. A quantity of cathode suspension can be stored in a reservoir 111. The energy storage device is connected to load 101.

Referring to FIG. 2, a schematic diagram of another embodiment depicts an energy storage device having negative and positive electrodes comprising anode and cathode suspensions, respectively, that can flow. The anode suspension 210 comprises particulates 213 that can comprise magnesium metal, an anode magnesium intercalation compound, and/or an anode magnesium conversion compound. The cathode suspension 209 can comprise particulates 212 of a cathode magnesium intercalation compound, a cathode magnesium conversion compound or both. The positive and negative suspensions can contact a positive electrode current collector 206 and a negative electrode current collector 205, respectively. The positive and negative electrodes are separated by separator 204. Furthermore, the cathode suspension can optionally flow into the positive electrode volume 214 along pathway 207 and out the positive electrode along pathway 202. Pathways 207 and 202 can be embodied by inlets and outlets to the positive electrode volume 214. Similarly, the anode suspension can optionally flow into the negative electrode volume 211 along pathway 208 and out the negative electrode along pathway 203. Pathways 208 and 203 can be embodied by inlets and outlets to the negative electrode volume 211. Alternatively, a single port can be used to remove and fill the positive and/or negative electrode volumes with the cathode and/or anode suspensions, respectively. Flow of the cathode and/or anode suspension can be provided by a pump, a piston, or any other means of moving a semi-solid or flowable material. A quantity of anode and/or cathode suspensions can be stored in reservoirs 215 and/or 216, respectively. The energy storage device is connected to load 201.

The Mg based battery systems can be superior to lithium or sodium based systems with similar configuration because Mg systems do not suffer the issue of metal dendrite formation or formation of an SEI (solid electrolyte interphase) layer. Metal dendrites present significant safety concerns. The formation of an SEI layer continuously consumes electrolyte and active materials such as Li/Na. In comparison with other Mg battery systems, which use volatile-solvent-based electrolytes (such as THF, boiling point=66° C.), the electrolyte solutions described above and elsewhere herein can have high boiling points. For example, the boiling point for diglyme, triglyme and tetraglyme are 162° C., 216° C., 275° C., respectively.

In one embodiment, the electrolyte solution comprises an organic solvent comprising diglyme, triglyme, tetraglyme, or a combination thereof. A first salt comprising a magnesium cation is substantially dissolved in the organic solvent. The solution further comprises a second salt that enhances the solubility of the first salt and comprises magnesium cation or a lithium cation. The first salt, the second salt, or both comprises a BH₄ anion. In some embodiments, the first salt can comprise Mg(TFSI)₂. In others, the first salt comprises Mg(BH₄)₂. For embodiments in which the first salt comprises the BH₄ anion, the second salt can comprise a Bis(trifluoromethanesulfonyl)Imide (TFSI) anion. Alternatively, the second salt can comprise a PF₆ anion. When configured accordingly, the energy storage device can have a negative electrode capacity fade less than 10% within 100 cycles.

As used herein, glyme, diglyme, triglyme, and tetraglyme can refer to dimethoxyethane (DME), diglycol methyl ether, triethylene glycol dimethyl ether, and tetrathylene glycol dimethyl ether, respectively. The term glymes can refer to any of DME, diglyme, triglyme, tetraglyme, or a combination thereof.

The cycling stability of the device when using the electrolyte solutions described above can be quantified by the Coulombic efficiency or the capacity fade within a certain number of cycles. In some instances, the negative electrode has a capacity fade less than 80% within 50 cycles. In other instances, the negative electrode has a capacity fade less than 10% within 50 cycles. Preferably, the negative electrode has a capacity fade less than 10% within 100 cycles. Most preferably, the negative electrode has no obvious capacity fade within 100 cycles.

In one example, an energy storage system included a magnesium metal foil as the negative electrode. An electrolyte solution comprised Mg(BH₄)₂ and LiBH₄ dissolved in diglyme. The positive electrode comprised a slurry having the electrolyte, carbon black as a conductive additive, and particulates of Mo₆S₈, which is a magnesium intercalation compound. The separator comprised a glass fiber membrane, although other conventional separators and membranes could also be suitable. The negative electrode, separator, and positive electrode were assembled in a cell having a positive electrode flow field, which was filled with slurry material. During discharge, magnesium is stripped from the anode and magnesium ions move through the separator towards the positive electrode, where they are inserted into the Mo₆S₈ particulates. During charging, magnesium ions are extracted from the Mo₆S₈ particulates and move through the separator towards the negative electrode, where metal is plated onto the magnesium metal foil. The cell was discharged and charged on an electrochemical workstation for evaluation.

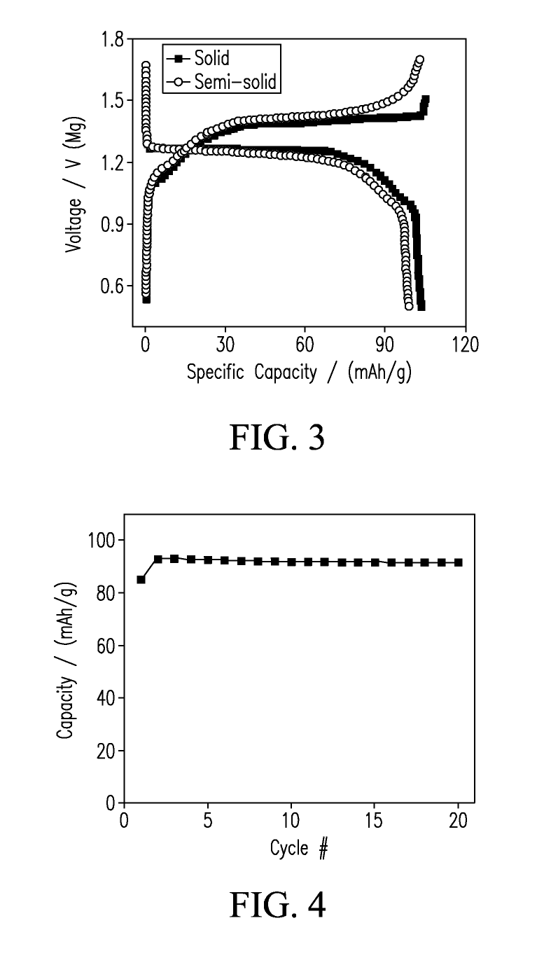

FIG. 3 includes a graph of capacity as a function of voltage for a traditional Mg coin cell having a static positive electrode compared to the example described above, which has a semi-solid Mo₆S₈ positive electrode that can flow and an electrolyte solution comprising Mg(BH₄)₂ and LiBH₄ dissolved in diglyme. The static and the semi-flow devices have similar discharge-charge profiles, indicating the cell with semi-solid electrode has the same discharge/charge behavior as the traditional coin cell but with unlimited active materials if operated with a flowing or replaceable cathode. This is very attractive for large scale energy storage because it has much less “overhead” dead mass or dead volume (i.e., the mass or volume of battery system components other than active materials, like packing, thermo-management, etc.). The cathode suspension can flow in a continuous or batch manner to ensure maximum performance of the energy storage device.

FIG. 4 includes a graph of capacity as a function of cycle number for the semi-flow device described above. The graph indicates that the semi-solid cell has a high cycling stability with a capacity over 90 mAh/g, which is close to the theoretical value of 120 mAh/g. The positive electrode exhibits a very low capacity fade as indicated by the coulombic efficiency, which is over 99%.

In another embodiment, the energy storage device utilizes an electrolyte comprising a Lewis acid and a salt comprising magnesium. The magnesium salt is not a Grignard reagent. Examples of magnesium salts include, but are not limited to, MgCl₂ and Mg—Ph—Cl. Preferably, the Lewis acid comprises AlCl₃ and/or AlCl₂Et. The instant electrolyte composition can exhibit improved electrochemical reversibility and a wide chemical window (up to 3.5 V vs. Mg/Mg²⁺). The positive electrode can comprise a suspension having particulates of a cathode magnesium intercalation or conversion compound. In such instances, the magnesium ions stripped from the negative electrode during discharge can be inserted into the particulates and then deserted during charging. Alternatively, the cathode suspension can have particulates comprising a redox active material. In one example, the redox active material can comprise sulfur. During discharge, magnesium ions can react with sulfur to yield MgS. During charging, the MgS can undergo a reaction back to sulfur.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An energy storage system having:
a negative electrode comprising magnesium;
a positive electrode comprising a cathode suspension contacting a positive current collector, the suspension comprising particulates of a cathode magnesium intercalation compound, a cathode magnesium conversion compound, a redox active species, or a combination thereof; and
a separator separating the positive and negative electrodes.

2. The energy storage system of claim 1, wherein the negative electrode comprises magnesium metal.

3. The energy storage system of claim 2, further comprising an electrolyte solution having an organic solvent selected from the group consisting of diglyme, triglyme, tetraglyme, and combinations thereof, a first salt substantially dissolved in the organic solvent and comprising a magnesium cation, and a second salt substantially dissolved in the organic solvent and comprising a magnesium cation or a lithium cation, wherein the first salt, the second salt, or both comprise a BH₄ anion.

4. The energy storage system of claim 2, further comprising an electrolyte solution comprising a Lewis acid and a salt having magnesium in an organic solvent.

5. The energy storage system of claim 4, wherein the salt having magnesium comprises MgCl₂, phenyl magnesium chloride, or both.

6. The energy storage system of claim 4, wherein the Lewis acid comprises AlCl₃, AlCl₂Et, or both.

7. The energy storage system of claim 4, wherein the redox active species comprises sulfur.

8. The energy storage system of claim 1, wherein the negative electrode comprises an anode magnesium intercalation compound, an anode magnesium conversion compound, or both.

9. The energy storage system of claim 1, wherein the negative electrode comprises a static electrode.

10. The energy storage system of claim 1, wherein the negative electrode comprises an anode suspension contacting a negative electrode current collector.

11. The energy storage system of claim 1, wherein the cathode magnesium intercalation compound comprises Mo₆S₈.

12. The energy storage system of claim 1, further comprising a reservoir having a quantity of the cathode suspension and being connected to the positive electrode.

13. The energy storage system of claim 1, further comprising an inlet and an outlet through which the cathode suspension flows to and from the positive electrode, respectively.

14. An energy storage system having a reservoir, a positive electrode, a static negative electrode, and a separator between the positive and static negative electrodes, the static negative electrode comprising magnesium metal or an anode magnesium intercalation compound, the positive electrode contacting a positive electrode current collector and comprising a suspension having particulates of a cathode magnesium intercalation or conversion compound, and the reservoir providing the suspension to the positive electrode.

15. An energy storage system comprising a stack having a plurality of cells, each cell having a positive electrode comprising a suspension having particulates of a cathode magnesium intercalation or conversion compound contacting a positive electrode current collector, a negative electrode comprising magnesium, a separator between the positive and negative electrodes, and at least one reservoir providing the suspension to the cells.

16. The energy storage system of claim 15, herein the negative electrode is a static electrode.

17. The energy storage system of claim 16, wherein the static electrode comprises magnesium metal.

18. The energy storage system of claim 15, wherein the cathode magnesium intercalation compound comprises Mo₆S₈.
